(19) United States
(12) Patent Application Publication
(10) Pub. No.: US 2026/0161122 A1
(43) Pub. Date: Jun. 11, 2026

(54) FIXING DEVICE

(71) Applicant: CANON KABUSHIKI KAISHA, Tokyo (JP)

(72) Inventors: SHOICHIRO IKEGAMI, Kanagawa (JP); TAKAAKI AKAMATSU, Kanagawa (JP); TORU IMAIZUMI, Kanagawa (JP); HIROKI SASAME, Tokyo (JP); MIKA MAEJIMA, Tokyo (JP)

(21) Appl. No.: 19/402,372

(22) Filed: Nov. 26, 2025

(30) Foreign Application Priority Data
Dec. 9, 2024 (JP) 2024-214581

(51) Int. Cl. G03G 15/20; G03G 21/16

(52) U.S. Cl. CPC G03G 15/2053; G03G 15/2064; G03G 21/1619; G03G 21/1647; G03G 2215/2035

(57) ABSTRACT

A fixing device includes a heating unit including an endless belt and a heater provided in an internal space of the belt, a pressure roller configured to form a nip portion for conveying a recording material together with the heater via the belt, a pressure spring, a pressure arm configured to press the heating unit toward the pressure roller by spring force of the pressure spring, and a resin frame configured to support the heating unit, wherein a metal support member is attached to the frame, and the frame rotatably supports the pressure roller via the support member.

### BACKGROUND

### Field of the Technology

The present disclosure relates to a fixing device provided in an image forming apparatus employing an electrophotographic method.

### Description of the Related Art

In an image forming apparatus employing an electrophotographic method, a fixing device adopting an on-demand fixing method, as described in Japanese Patent Laid-Open No. 2024-31208, is known.

### SUMMARY

According to some embodiments of the present disclosure, a fixing device includes a heating unit including an endless belt and a heater provided in an internal space of the belt, a pressure roller configured to form a nip portion for conveying a recording material together with the heater via the belt, a pressure spring, a pressure arm configured to press the heating unit toward the pressure roller by spring force of the pressure spring, and a resin frame configured to support the heating unit, wherein a metal support member is attached to the frame, and the frame rotatably supports the pressure roller via the support member.

A fixing device that is an improvement over the conventional configuration is provided.

Features of the present disclosure will become apparent from the following description of embodiments with reference to the attached drawings. The following description of embodiments is described by way of example.

### BRIEF DESCRIPTION OF THE DRAWINGS

FIGS. 1A and 1B are perspective views of a fixing device according to a first embodiment.

FIG. 2 is a cross-sectional view of an image forming apparatus according to the first embodiment.

FIG. 3 is a cross-sectional view of a heating unit and a pressure roller according to the first embodiment.

FIG. 4 is a cross-sectional view of the fixing device according to the first embodiment.

FIG. 5A is a cross-sectional view and FIG. 5B is an exploded perspective view of the fixing device according to the first embodiment.

FIG. 6 is a top view of a holder according to the first embodiment.

FIG. 7 is an exploded perspective view of the heating unit according to the first embodiment.

FIG. 8 is a top view of the heating unit according to the first embodiment.

FIG. 9A is a front view, and FIGS. 9B, 9C, and 9D are cross-sectional views of the fixing device according to the first embodiment.

FIG. 10A is a top view, and FIGS. 10B and 10C are enlarged views of a lower frame and a pressure roller according to the first embodiment.

FIG. 11A is a cross-sectional view of a pressure mechanism and a pressure release mechanism in a pressurized state and FIG. 11B is a cross-sectional view of the pressure mechanism and the pressure release mechanism in a pressure release state according to the first embodiment.

FIG. 12 is an exploded perspective view of a lower frame, an upper frame, a cam shaft, and a cam according to the first embodiment.

FIG. 13A is a cross-sectional view and FIG. 13B is an exploded perspective view of a fixing device according to comparative example 1.

FIG. 14A is a cross-sectional view and FIG. 14B is an exploded perspective view of a fixing device according to a second embodiment.

### DESCRIPTION OF THE EMBODIMENTS

### First Embodiment

Hereinafter, various exemplary embodiments, features, and aspects of the present disclosure will be described in detail with reference to the drawings.

### Image Forming Apparatus

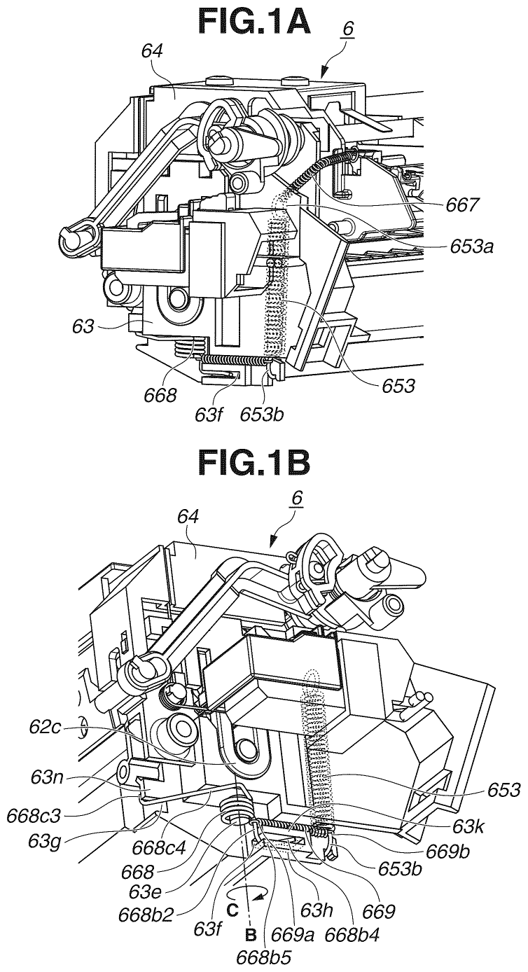

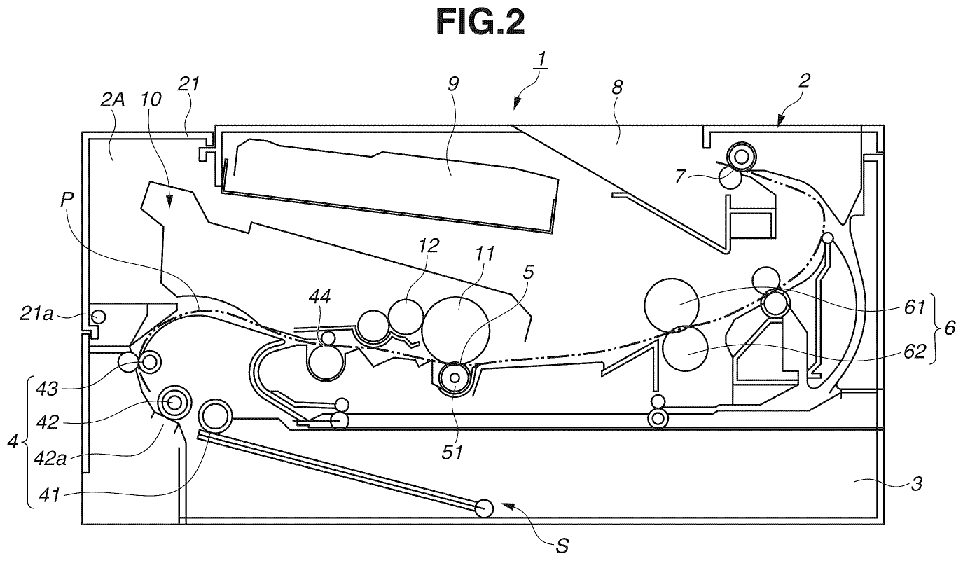

FIGS. 1A and 1B are perspective views of a fixing device according to a first embodiment, and FIG. 2 is a cross-sectional view of an image forming apparatus 1 employing an electrophotographic method according to the present embodiment. However, dimensions, materials, shapes, and relative arrangements of the components described in the embodiments may be appropriately changed depending on the configuration of the apparatus to which the present disclosure is applied and various conditions. Therefore, unless otherwise specifically stated, the scope of the present disclosure is not limited thereto. In the following description, the left side in FIG. 2 is defined as the front side of the image forming apparatus 1, the right side as the rear side of the image forming apparatus 1, the near side of the drawing as the right side of the image forming apparatus 1, and the far side as the left side of the image forming apparatus 1. The upper and lower sides in FIG. 2 are defined as the upper and lower sides of the image forming apparatus 1, respectively.

As illustrated in FIG. 2, the image forming apparatus 1 includes a main body 2 of the image forming apparatus 1, and a process cartridge 10 is detachably mounted on the main body 2. The main body 2 is provided with a paper feed tray 3, a recording material feeding unit 4, a conveyance path P, an image forming unit 5, a fixing device 6, a recording material discharge unit 7, a discharge tray 8, a laser scanner 9, and other units. The cartridge 10 is provided with a photosensitive drum 11, a developing roller 12 serving as a developer carrying member, and other components.

The main body 2 is provided with an opening 2A for attaching and detaching the process cartridge 10, and an open/close door 21 for closing the opening 2A. The open/close door 21 is rotatably supported about a rotation shaft 21a and is movable between a closed position for closing the opening 2A and an open position for opening the opening 2A.

The recording material feeding unit 4 includes a paper feed roller 41, a separation roller 42, a separation pad 42a, and a conveyance roller pair 43. A recording material S stored in the paper feed tray 3 is fed to the conveyance path P by the recording material feeding unit 4 based on a print start signal, and is conveyed toward the image forming unit 5 via a registration roller pair 44. When the recording material S is conveyed to a predetermined position, an image forming start signal is issued, and an image forming process is started. A photosensitive drum 11, which is rotationally driven by a drive source (motor) not shown, is uniformly charged to a predetermined potential by a charging unit not illustrated. The surface of the charged photosensitive drum 11 is exposed by the laser scanner 9 based on image information, and charge in the exposed portions is removed to form an electrostatic image. Toner in the process cartridge 10 is carried on the developing roller 12 and supplied to the photosensitive drum 11 in accordance with the electrostatic latent image to develop the latent image. Thus, the latent image is visualized as a toner image on the photosensitive drum 11.

The image forming unit 5 includes the process cartridge 10 and a transfer roller 51 disposed to face the photosensitive drum 11 of the process cartridge 10. When the recording material S conveyed by the registration roller pair 44 reaches the image forming unit 5 and passes through a transfer nip portion between the photosensitive drum 11 and the transfer roller 51, a voltage is applied to the transfer roller 51 from the main body 2, and the toner image on the photosensitive drum 11 is transferred to the recording material S. Thereafter, the recording material S to which the toner image has been transferred is conveyed to the fixing device 6 including a heating unit 61 and a pressure roller 62 that contacts an outer peripheral surface of a cylindrical belt 614. When the recording material S is nipped and conveyed through a fixing nip portion NP1 between the heating unit 61 and the pressure roller 62, the toner image transferred onto the recording material S is heated and pressed to be fixed to the surface of the recording material S. The recording material S on which the toner image has been fixed is discharged to the discharge tray 8 via the recording material discharge unit 7.

### Fixing Device

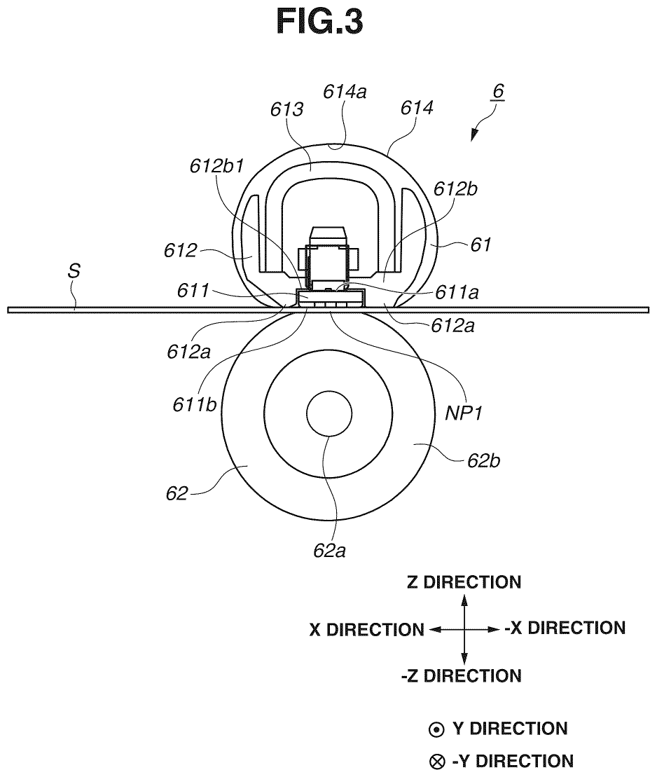

Next, a specific configuration of the fixing device will be described with reference to FIGS. 3 to 8. As illustrated in FIG. 3, the heating unit 61 included in the fixing device 6 includes a heater 611, a holder 612, a stay 613, and a belt 614. The heater 611, the holder 612, and the stay 613 are disposed in an internal space of the belt 614. When the X direction, the Y direction, and the Z direction are defined as illustrated in FIG. 3, the heater 611 is a flat plate extending in the Y direction, and the Y direction coincides with a longitudinal direction of the heater 611. The heater 611 has a first surface 611a and a second surface 611b opposite to the first surface 611a, and the first surface 611a is supported by the holder 612.

The holder 612 is formed of a resin having heat resistance, such as polyphenylene sulfide (PPS) or liquid crystal polymer, and has a guide surface 612a and a support wall 612b. The guide surface 612a contacts an inner peripheral surface 614a of the belt 614 to guide the belt 614, and the support wall 612b has a support surface 612b1 that supports the heater 611. The support surface 612b1 of the support wall 612b is in contact with the first surface 611a of the heater 611. The stay 613 is a member that supports the holder 612 and is formed by bending a plate material having higher rigidity than the holder 612, for example, a steel plate having a thickness of 1.6 mm, into a substantially U shape.

The belt 614 is an endless belt having heat resistance and flexibility, and examples thereof include a metal sleeve, such as stainless steel, coated with fluororesin, or a laminated structure of polyimide resin, silicone rubber, fluororesin, and the like. The heater 611, the holder 612, and the stay 613 are disposed inside the belt 614, and the belt 614 rotates around these members. The inner peripheral surface 614a of the belt 614 contacts the second surface 611b of the heater 611.

The pressure roller 62 includes a metal shaft 62a serving as a shaft portion and a roller 62b made of an elastic member covering the shaft 62a, and is pressed against the heater 611 via the belt 614. The pressure roller 62 forms the fixing nip portion NP1 for nipping and heating and pressing the recording material S by sandwiching the belt 614 between the pressure roller 62 and the heater 611. That is, the pressure roller 62 heats and presses the recording material S together with the heater 611 at the fixing nip portion NP1.

The pressure roller 62 is configured to be rotationally driven by driving force transmitted from a drive source provided in the image forming apparatus 1. When the pressure roller 62 is rotationally driven, the belt 614 is rotated in a follower manner by frictional force with the pressure roller 62 or with the recording material S nipped in the fixing nip portion NP1. As a result, the recording material S to which the toner image has been transferred is conveyed between the pressure roller 62 and the heated belt 614, whereby the toner image is thermally fixed.

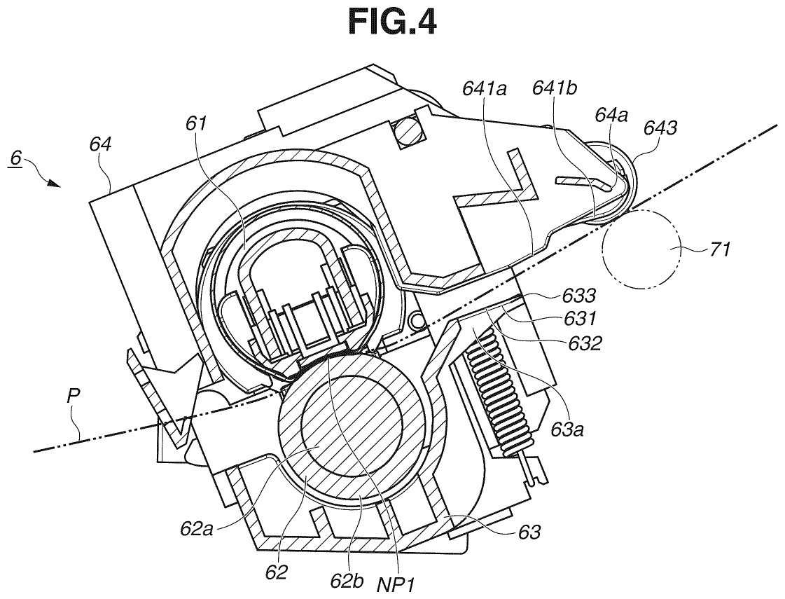

As illustrated in FIGS. 4 to 8, the fixing device 6 includes a lower frame 63 that supports the heating unit 61 and the pressure roller 62, and an upper frame 64 that is positioned above the lower frame 63 and covers the heating unit 61. The upper frame 64 has an upper recording material guide 64a that guides an upper surface of the recording material S conveyed along the conveyance path P on a downstream side of the heating unit 61 and the pressure roller 62 in a recording material conveyance direction. The lower frame 63 has a lower recording material guide 63a that guides a lower surface of the recording material S conveyed along the conveyance path P on a downstream side of the heating unit 61 and the pressure roller 62 in the recording material conveyance direction.

The conveyance path P in the fixing device 6 extends in the X direction. In this embodiment, the lower frame 63 and the upper frame 64 are formed of, for example, non-conductive molded members. For example, the material of the molded members may be polyethylene terephthalate (PET), polybutylene terephthalate (PBT), or PPS. PET or PBT may be reinforced with glass fibers.

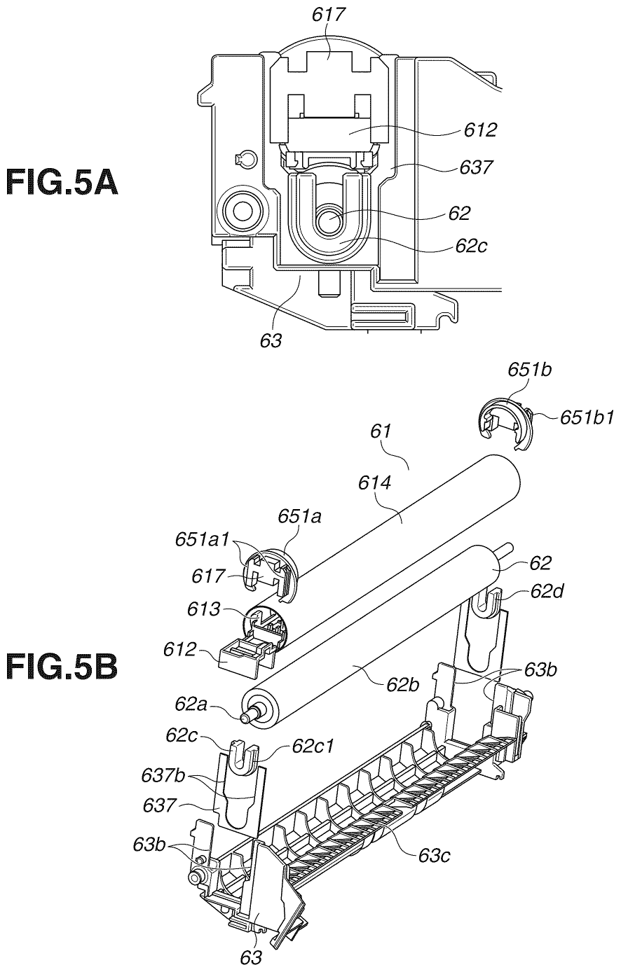

As illustrated in FIG. 5A, the lower frame 63 directly supports the heating unit 61. The lower frame 63 has a pair of rails 63b at respective ends in the Y direction. As illustrated in FIG. 5B, a support member 637 is fitted and attached to the rails 63b provided on both side portions of the lower frame 63. Here, the rails 63b may be each a U-shaped groove. The rails 63b are each a columnar portion extending in the Z direction from a main body 63c of the lower frame 63. A bearing 62c is attached to the support member 637, and the pressure roller 62 is disposed and supported on the bearing 62c.

As illustrated in FIG. 5B, the heating unit 61 is supported by fitting a groove provided in a transmission member 651 into a groove portion 637b provided in the metal support member 637. In addition, a protrusion 62c1 provided on a bearing 62c fits into the groove portion 637b provided in the support member 637, thereby positioning the bearing 62c. A pair of inner surfaces of the groove portion 637b face each other in the X direction. The opposing inner surfaces of the groove portion 637b engage with groove portions 651a1 and 651b1 provided in transmission members 651a and 651b, respectively. Note that although the rails 63b are each a columnar portion extending in the Z direction according to the present embodiment, the shape is not limited to this as long as the holder 612 can be supported by the rails 63b so as to be movable in the Z direction.

The pressure roller 62 is rotatably held on the lower frame 63 via the bearings 62c and 62c at both longitudinal ends of the metal shaft 62a.

In this embodiment, the bearing 62c is desirably a resin sliding bearing in order to prevent metal contact with the support member 637. The transmission member 651 is pressed by a pressure arm 652 to transmit spring force in the Z direction to the stay 613. Furthermore, the pressure applied to the stay 613 is applied to the holder 612 and the heater 611, thereby forming the fixing nip NP1 between the heater 611 and the pressure roller 62. The support member 637 is formed of a stainless steel plate (Steel Use Stainless (SUS) 304) having a thickness of 1.0 mm to have sufficient rigidity to hold the transmission member 651 in engagement. The rail 63b may be a U-shaped groove, and the support member 637 may have a U-shaped configuration to be fitted into the U-shaped groove.

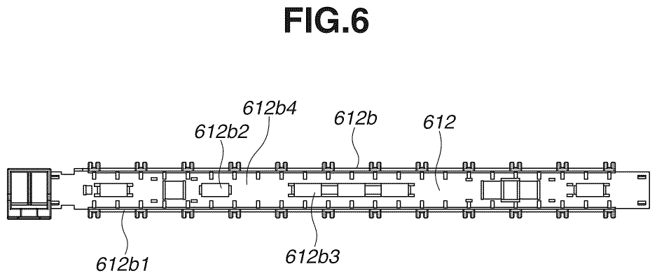

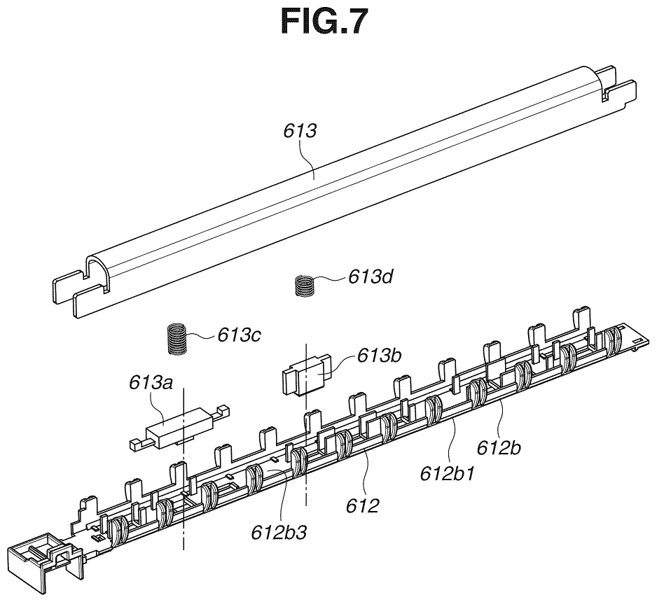

As illustrated in FIG. 6, the support wall 612b of the holder 612 has a plurality of holes 612b2 and 612b3. As illustrated in FIG. 7, temperature sensors 613a and 613b are disposed facing a back surface 612b4 of the holder 612 opposite to the support surface 612b1. As illustrated in FIG. 7, the temperature sensors 613a and 613b contact the first surface 611a of the heater 611 through the holes 612b2 and 612b3. The temperature sensors 613a and 613b are pressed against the first surface 611a of the heater 611 (see FIG. 3) by urging members 613c and 613d provided between the stay 613 and the temperature sensors 613a and 613b. The temperature sensor 613a is located at one end of the holder 612 in the Y direction. The temperature sensor 613b is located closer to one end than the center of the holder 612 in the Y direction. The temperature sensors 613a and 613b are thermistors in the present embodiment, but may be other temperature sensors, such as thermostats. The urging members 613c and 613d are coil springs in the present embodiment, but may be other urging members.

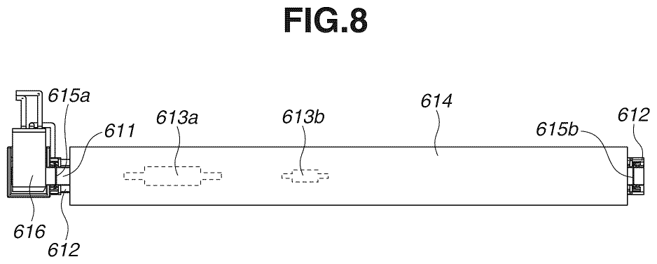

As illustrated in FIGS. 5B and 8, the holder 612 extends in the Y direction through the inside of the belt 614, and both ends in the Y direction protrude outward from the belt 614. The holder 612 supports the heater 611, and one end of the heater 611 in the Y direction is provided with a first wire spring 615a for holding the heater 611 on the holder 612 and a connector 616 for supplying power to the heater 611 and clamping the heater 611 and the holder 612. The other end of the heater 611 in the Y direction is provided with a second wire spring 615b for holding the heater 611 on the holder 612.

The temperature sensors 613a and 613b are located closer to the first wire spring 615a than to the second wire spring 615b in the Y direction. The first wire spring 615a is provided between the belt 614 and the connector 616. The second wire spring 615b is provided in a region protruding outward from the belt 614 on the opposite end where the first wire spring 615a is disposed. In this embodiment, the pressure roller 62 includes the shaft 62a and the roller 62b, but the configuration is not limited thereto, and a pressure belt pressed against a heating roller by an elastic member may be provided.

### Pressure Mechanism

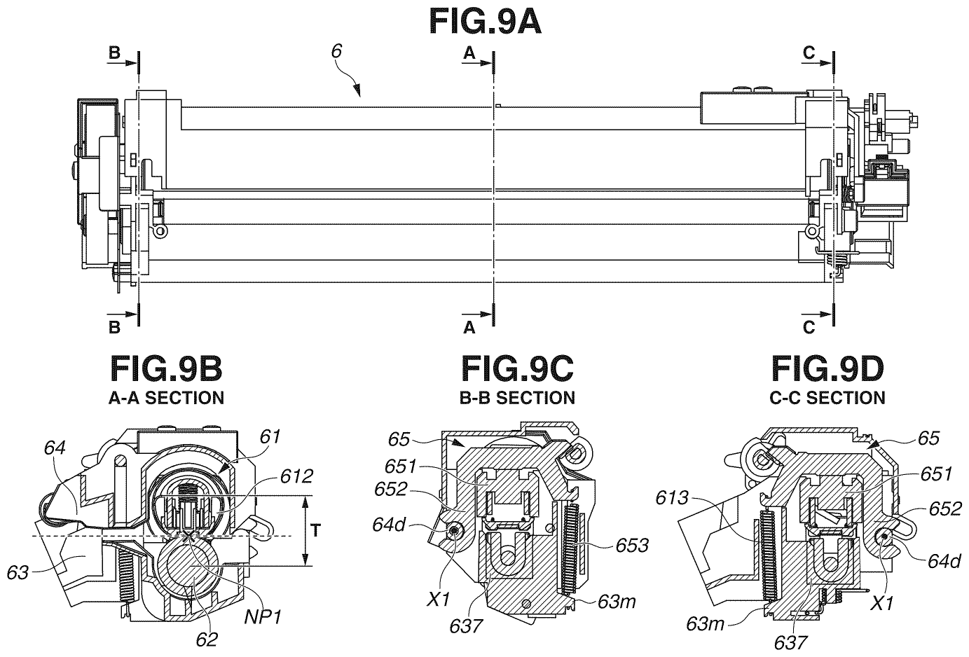

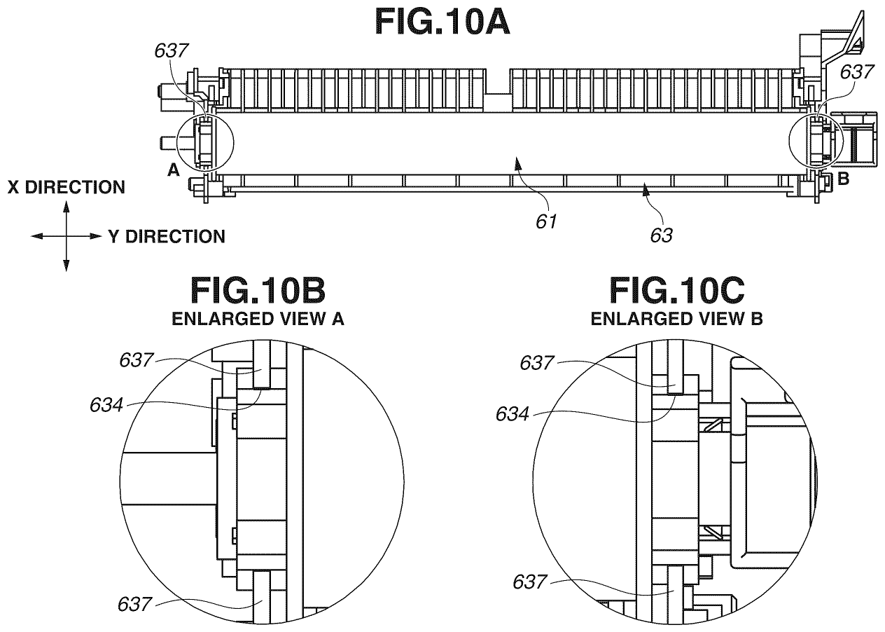

As illustrated in FIGS. 9A to 9D and 10A to 10C, the fixing device 6 includes a pressure mechanism 65 that applies pressure to form the fixing nip portion NP1 between the heating unit 61 and the pressure roller 62. The pressure mechanism 65 is located at each end of the lower frame 63 in the Y direction. Since the structure of the pressure mechanism 65 on one side and the structure on the other side in the Y direction are substantially the same, the following description mainly focuses on one side of the pressure mechanism 65 in the Y direction.

The pressurizing mechanism 65 includes a pressure-transmitting member (transmission member 651) that transmits pressure to the stay, which supports the heating unit 61 at an end in the Y direction and supported by the groove portion 637b so as to be movable in the Z direction. The pressure mechanism 65 further includes a pressure arm 652 that applies pressure to the transmission member 651 in a state where the transmission member 651 is mounted on the lower frame 63 and the support member 637 to form the fixing nip portion NP1. In addition, the pressure mechanism 65 includes a pressure spring 653 that generates pressure to press the pressure arm 652 against the transmission member 651, the pressure spring 653 being stretched between the lower frame 63 and the pressure arm 652. The lower frame 63 has a support portion 64d that rotatably supports the pressure arm 652 about a rotation center shaft X1. The support portion 64d is a substantially cylindrical projection. The pressure spring 653 is a tension coil spring that biases the pressure arm 652 toward the pressure roller 62. The lower frame 63 has a spring hook portion 63m on which one end of the pressure spring 653 is hooked. For example, the portion of the resin lower frame 63 corresponding to the support portion 64d may be made of metal, or only a portion of the support portion 64d that contacts the pressure arm 652 may be provided with a metal member. The portion of the resin lower frame 63 corresponding to the spring hook portion 63m may also be made of metal.

At least a part of the rotation center shaft X1 about which the pressure arm 652 rotates is located, when viewed in the Y direction, on an upstream side in the recording material conveyance direction relative to the fixing nip portion NP1 and within a range T in the Z direction illustrated in FIG. 9B. Here, the range T in the Z direction illustrated in FIG. 9B is a range between a rotation center of the pressure roller 62 in the Z direction and an end of the holder 612 on the pressure arm side in the Z direction (the end of the holder 612 farthest from the rotation center of the pressure roller in the Z direction). Since there is a distance in the Z direction between a portion where the pressure arm 652 presses the transmission member 651 and the rotation center shaft X1, the pressure arm 652 is bent into an L shape. The upstream side in the recording material conveyance direction refers to the side closer to the photosensitive drum 11 than the fixing nip portion NP1 in the X direction.

### Pressure Release Mechanism

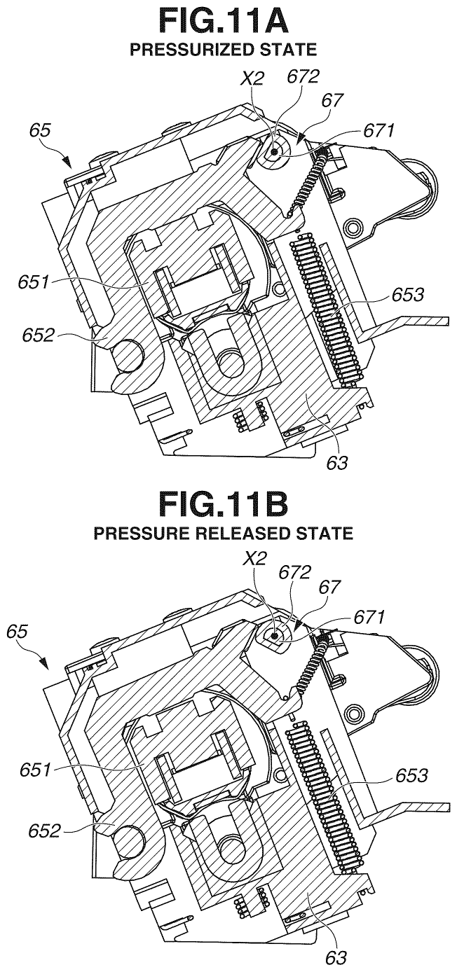

As illustrated in FIGS. 11A and 11B, the fixing device 6 further includes a pressure release mechanism 67 for releasing nip pressure applied to the fixing nip portion NP1 between the heating unit 61 and the pressure roller 62 in FIG. 9B. The pressure release mechanism 67 includes a cam shaft 671 and a cam 672. The lower frame 63 supports the pressure spring 653 and rotatably supports the pressure arm 652 and the cam 672. The cam 672 is located at each end of the lower frame 63 in the Y direction. Since the structure of the pressure release mechanism 67 on one side in the Y direction and the structure on the other side are substantially the same, the following description mainly represents the structure on one side in the Y direction.

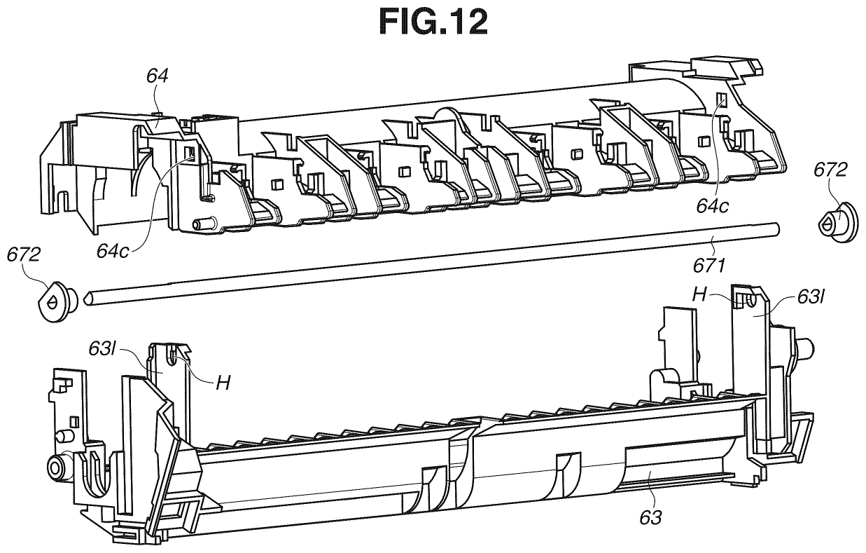

As illustrated in FIG. 12, the cam shaft 671 extends in the Y direction. The cam shaft 671 is made of, for example, metal. A cam 672 is fixed to each end of the cam shaft 671 in the Y direction. In other words, the cam 672 has the cam shaft 671. The cam 672 rotates together with the rotation of the cam shaft 671. The lower frame 63 has shaft support portions 63l that rotatably support the cam shaft 671. As illustrated in FIG. 12, the shaft support portions 63l are disposed at one end and the other end of the lower frame 63 in the Y direction, respectively. Each shaft support portion 63l has a hole H that rotatably supports the cam shaft 671.

As illustrated in FIG. 12, the upper frame 64 has grooves 64C that rotatably support the cam shaft 671. The grooves 64C are disposed at one end and the other end of the upper frame 64 in the Y direction, respectively. The cam shaft 671 is held between the upper frame 64 and the lower frame 63. As illustrated in FIGS. 11A and 11B, the cam shaft 671 is rotatably supported about a shaft X2. The cam 672 can press the pressure arm 652 against the biasing force of the pressure spring 653. Specifically, the cam 672 is rotatable between a first position illustrated in FIG. 11A and a second position illustrated in FIG. 11B.

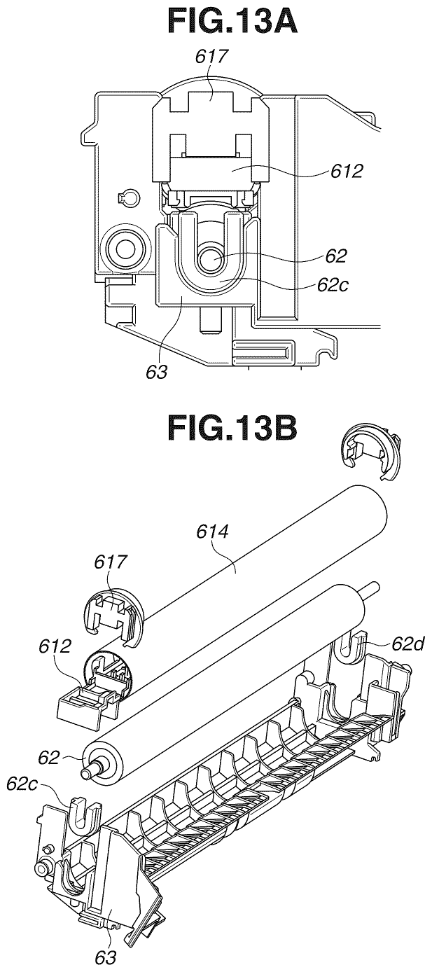

A comparative example 1 is illustrated in FIGS. 13A and 13B. In the comparative example, as illustrated in FIG. 13A, the support member 637 is not provided, and the bearing 62c directly contacts the lower frame 63. In contrast, according to the first embodiment, by forming the side plate portion itself as a metal member, it is possible to increase the rigidity for holding the pressure roller compared to the comparative example 1 and to achieve accurate retention of the heating unit 61 and the pressure roller 62. The positional relationship between the pressure roller 62, which serves as a drive source, and the heating unit 61 is desirably maintained throughout the product life without being affected by external factors, such as load, heat, and sliding friction. In the present embodiment, by incorporating the support member 637 partially applying a metal material having higher strength, higher heat resistance, and superior wear resistance than the lower frame 63 as material properties, it is possible to prevent the occurrence of creep and to achieve stable fixing performance, image quality, and high durability throughout the product life.

### Second Embodiment

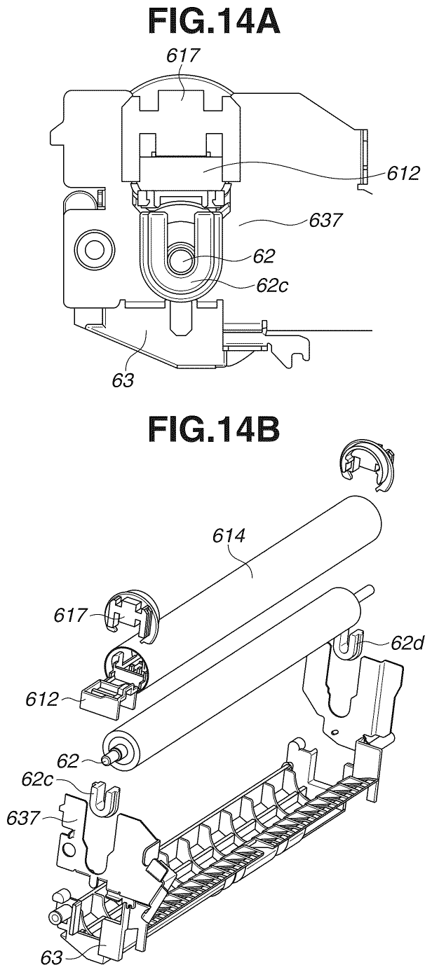

In this embodiment, the same configuration and control as in the first embodiment are denoted by the same reference numerals and description thereof is omitted. In this embodiment, as illustrated in FIG. 14A, the support member 637 is larger than that in the first embodiment and covers the entire side portion of the fixing device 6. The support member 637 is fixed to the lower frame 63. With this configuration, the rigidity of the fixing device can be increased compared to the first embodiment.

### Third Embodiment

In a third embodiment, the same configuration and control as in the first and second embodiments are denoted by the same reference numerals and description thereof is omitted. The metal support member 637 described in the first and second embodiments may be replaced with a super engineering plastic. Examples of the material of the support member 637 include polyacetal (POM), polyamide (PA), polycarbonate (PC), modified polyphenylene ether (m-PPE), and polybutylene terephthalate (PBT).

By using a super engineering plastic for the support member 637, it is possible to achieve high heat resistance and high rigidity while preventing discharge from the inside of the image forming apparatus compared to the case of using metal.

### Fourth Embodiment

In a fourth embodiment, the same configuration and control as in the first to third embodiments are denoted by the same reference numerals and description thereof is omitted. In the first embodiment, the bearing 62c is made of resin, but in the fourth embodiment, the bearing is made of metal, such as a ball bearing. In this case, in order to prevent metal contact between the bearing and the support member 637, a resin member may be provided between the bearing and the support member 637. By using a metal bearing, the load capacity can be increased compared to a resin bearing.

### Additional Notes

The disclosure of the embodiments further includes the following configuration examples.

### Item 1

A fixing device including: a heating unit including an endless belt and a heater provided in an internal space of the belt; a pressure roller configured to form a nip portion for conveying a recording material together with the heater via the belt; a pressure spring; a pressure arm configured to press the heating unit toward the pressure roller by spring force of the pressure spring; and a resin frame configured to support the heating unit, wherein a metal support member is attached to the frame, and the frame rotatably supports the pressure roller via the support member.

### Item 2

The fixing device according to item 1, wherein the frame supports the heating unit movably via the support member.

### Item 3

The fixing device according to any one of items 1 to 2, wherein the frame directly supports the heating unit.

### Item 4

The fixing device according to any one of items 1 to 3, wherein the support member is U-shaped and is attached along a U-shaped groove of the frame.

### Item 5

The fixing device according to any one of items 1 to 4, wherein the support member is a plate-shaped member, and a portion supporting the pressure roller is recessed so as to support the pressure roller.

### Item 6

The fixing device according to any one of items 1 to 5, wherein the pressure roller includes a shaft portion, an elastic portion provided around the shaft portion, and a bearing attached to the shaft portion, the support member directly supports the bearing, and the bearing is a sliding bearing.

### Item 7

The fixing device according to any one of items 1 to 6, wherein the pressure roller includes a shaft portion, an elastic portion provided around the shaft portion, and a bearing attached to the shaft portion, wherein the bearing is made of metal, and wherein a resin member is provided between the bearing and the support member so that the bearing is supported by the support member via the resin member.

While the present disclosure has been described with reference to embodiments, it is to be understood that the present disclosure is not limited to the disclosed embodiments. The scope of the following claims is to be accorded the broadest interpretation so as to encompass all such modifications and equivalent structures and functions.

This application claims the benefit of priority from Japanese Patent Application No. 2024-214581, filed Dec. 9, 2024, which is hereby incorporated by reference herein in its entirety.

What is claimed is:

1. A fixing device comprising:
a heating unit including an endless belt and a heater provided in an internal space of the belt;
a pressure roller configured to form a nip portion for conveying a recording material together with the heater via the belt;
a pressure spring;
a pressure arm configured to press the heating unit toward the pressure roller by spring force of the pressure spring; and
a resin frame configured to support the heating unit,
wherein a metal support member is attached to the frame, and the frame rotatably supports the pressure roller via the support member.

2. The fixing device according to claim 1, wherein the frame supports the heating unit movably via the support member.

3. The fixing device according to claim 1, wherein the frame directly supports the heating unit.

4. The fixing device according to claim 1, wherein the support member is U-shaped and is attached along a U-shaped groove of the frame.

5. The fixing device according to claim 1, wherein the support member is a plate-shaped member, and a portion supporting the pressure roller is recessed so as to support the pressure roller.

6. The fixing device according to claim 1,
wherein the pressure roller includes a shaft portion, an elastic portion provided around the shaft portion, and a bearing attached to the shaft portion,
wherein the support member directly supports the bearing, and
wherein the bearing is a sliding bearing.

7. The fixing device according to claim 1,
wherein the pressure roller includes a shaft portion, an elastic portion provided around the shaft portion, and a bearing attached to the shaft portion,
wherein the bearing is made of metal, and
wherein a resin member is provided between the bearing and the support member so that the bearing is supported by the support member via the resin member.
